(19) United States
(12) Patent Application Publication
(10) Pub. No.: US 2006/0061563 A1
(43) Pub. Date: Mar. 23, 2006

(54) Power-management method and system for electronic appliances

(76) Inventor: Rod G. Fleck, Bellevue, WA (US)

Correspondence Address: OLYMPIC PATENT WORKS PLLC, P.O. BOX 4277, SEATTLE, WA, 98104, US

(21) Appl. No.: 10/943,796

(22) Filed: Sep. 17, 2004

(51) Int. Cl. G09G 5/00

(52) U.S. Cl. 345/211

(57) ABSTRACT

Various embodiments of the present invention are directed to power-management methods for preventing needless dissipation of stored energy in operation of display components of electronic appliances, as well as for moving functionality from separately controlled and powered devices to a main display component in order to avoid unnecessary hardware, firmware, and software design and manufacturing complexities. In one embodiment of the present invention, techniques are applied in an electronic, information-displaying appliance using an organic-light-emitting-diode-based display component to increase the proportion of the display screen that appears dark, and that is therefore not emitting light, in order to decrease power consumption by the display component.

### TECHNICAL FIELD

The present invention is related to power-management methods and systems for electronic appliances and, in particular, to power-management methods and systems that take advantage of power-consumption characteristics of display components based on display components that directly emit light without the need for backlighting, such as organic-light-emitting-diode-based display components, in order to avoid unnecessary power consumption while displaying textual and graphic information.

### BACKGROUND

During the past 30 years, computer displays have evolved from relatively primitive, 24-line, text-based terminals, commonly used in minicomputer systems during the 1970s and early 1980s, to full color, high resolution CRT and flat panel displays commonly encountered in modern personal computers (“PCs”), workstations, and handheld electronic devices. The capabilities of modern display devices have led to increasing use of color, graphics, and even full motion video images to facilitate routine interactions between computer users and operating systems, application programs, and other user-interface-employing software systems running in computing environments provided by modern operating systems.

Although the capabilities and processing speeds of modern processors have continued to increase and evolve at spectacular rates, much of the increase in processing bandwidth is devoted to providing more intricate and capable graphical interfaces. Not only do interfaces displayed on display components consume a large fraction of available processor cycles and internal bus bandwidths, display components, particularly in portable PCs and other portable electronic appliances, consume a large fraction of the total power expended to operate them. For these reasons, designers and manufacturers of electronic, information-displaying devices, including handheld PCs, continually seek methods for more efficient power management with respect to information display and, more generally, for less expensive, simpler designs that avoid unnecessary use of specialized hardware and software to support particular features and components.

### SUMMARY

Various embodiments of the present invention are directed to power-management methods for preventing needless dissipation of stored energy in operation of display components of electronic appliances, as well as for moving functionality from separately controlled and powered devices to a main display component in order to avoid unnecessary hardware, firmware, and software design and manufacturing complexities. In one embodiment of the present invention, techniques are applied in an electronic, information-displaying appliance using an organic-light-emitting-diode-based display component to increase the proportion of the display screen that appears dark, and that is therefore not emitting light, in order to decrease power consumption by the display component. A second embodiment of the present invention involves moving various keyboard and auxiliary display components to a main, organic-light-emitting-diode-based display component where they can be continuously displayed against a black background in a low power-consuming display mode, rather than requiring specialized hardware, firmware, and software support as separate components. A third embodiment of the present invention is directed to adjusting voltage and/or other signal levels applied to operate an organic-light-emitting-diode-based device in order to compensate for degradation of the device, over time. Power-management methods and systems that represent various embodiments of the present invention may be relatively constantly applied, or may be dynamically invoked and adjusted in response to detection of decreasing stored energy levels within energy-storage components of an electronic appliance.

### BRIEF DESCRIPTION OF THE DRAWINGS

FIG. 1 shows a handheld PC.

FIG. 2 shows the location of the LID module on the top surface of the handheld PC, shown in FIG. 1.

FIGS. 3A-3B illustrate the fundamental principle of operation of a single cell of a thin film transistor, active matrix, liquid crystal display (“LCD”) device.

FIG. 4 illustrates operation of a thin film transistor, active matrix, liquid crystal display (“LCD”) device.

FIG. 5 shows different layers of a typical OLED.

FIG. 6 shows anode columns and cathode rows in one type of OLED.

FIG. 7 illustrates a single cell within the OLED shown in FIGS. 5 and 6.

FIG. 8 shows a rectangular grid of pixels on the surface of a portion of an OLED.

FIGS. 9A-F illustrate power-consumption-decreasing methods that represent embodiments of the present invention.

FIGS. 10A-10B show the graphics shown in FIGS. 9A and 9C, respectively, at one third their original sizes, centered on a black background.

FIG. 11 illustrates incorporation of separate components in displayed components on the main display component of a handheld PC.

FIG. 12A shows an example of low power-consuming display of separately illuminated keys and a portion of a LID module.

FIGS. 12B-G show a preferred embodiment for low power-consuming display of the LID module and various separately illuminated keys.

FIG. 13 illustrates a discrete, power-consumption-decreasing strategy.

FIG. 14 illustrates quasi-continuous, paramterized power-consumption-decreasing strategies.

FIG. 15 is a control-flow diagram of a configuration routine that configures an electronic, information-displaying device to operate in a low power-consuming display mode.

FIG. 16 is a control-flow diagram of a power-management routine that may be periodically invoked in order to manage power consumption by a display component according to various embodiments of the present invention.

### DETAILED DESCRIPTION

Various embodiments of the present invention are directed to methods for efficiently powering display components of portable electronic devices in order to both preserve battery life and to increase usability and availability of displayed information without increasing hardware and software complexity and power consumption. Various embodiments of the present invention, discussed below, relate to PCs, handheld PCs, and other portable electronic appliances, including various types of personal digital assistants (“PDAs”) that feature displays using direct light-emitting materials. In many modern display component technologies, efficient power management may also be directly related to extending the lifetimes of the display components. For direct light-emitting materials, lifetimes may be directly related to the amount of time during which, and the intensity at which, the device emits light. Decreasing power consumption by such devices generally results in decreasing both the time and intensity of light emission, thereby extending the overall lifetime of the component. For these reasons, the methods and systems of the present invention for efficiently powering display components are of potential utility in PCs, including handheld PCs, PDAs, and other types of electronic devices.

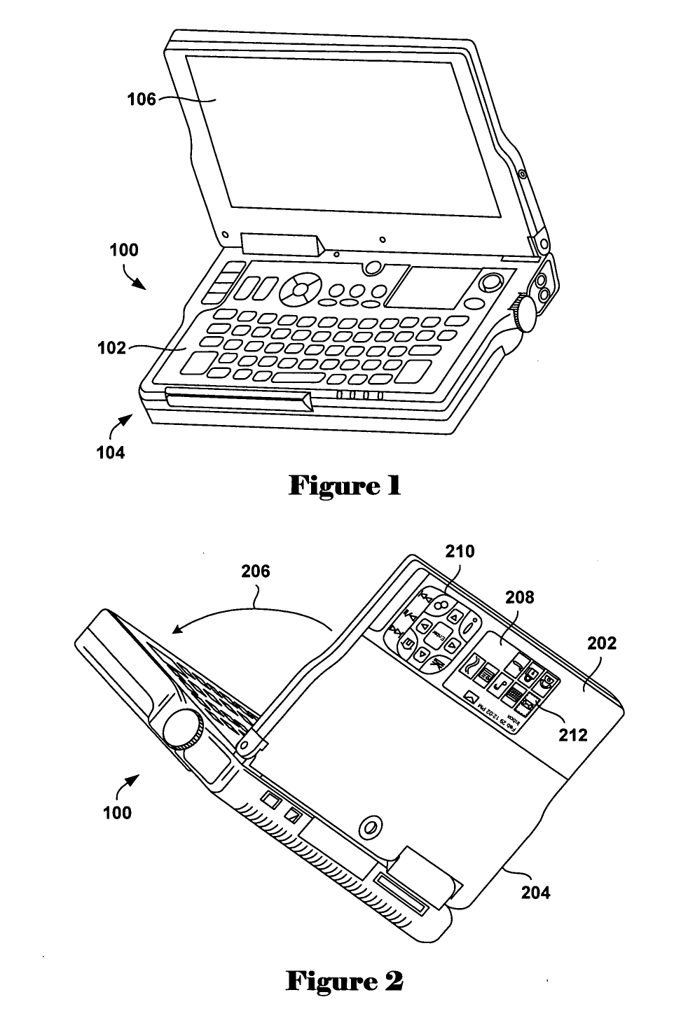

Recently, efforts have been undertaken to produce handheld PCs. FIG. 1 shows a handheld PC. The handheld PC 100 includes an integrated keyboard 102 on the top surface of an enclosed chassis 104 that contains the internal components of the handheld PC, including batteries, processors, a hard disk, memory, circuit boards, and other internal components. The handheld PC additionally includes a display component 106 for display of text and graphical information and input of commands. The handheld PC looks similar to a commonly available notebook PC, but is significantly smaller and lighter.

In order to extend battery life, as well as to extend convenience and usability, the handheld PC additionally includes a low power, interactive display (“LID”) module for continuous, low power-consuming, monochrome display of useful information and input of commands when the main display component 106 and other internal components, such as the hard disk and high power processor, are powered off. FIG. 2 shows the location of the LID module on the top surface of the handheld PC, shown in FIG. 1. As can be seen in FIG. 2, the LID module 202 is located on the surface of the cover 204 of the handheld PC opposite from the surface on which the main display component (106 in FIG. 1) is located. When the cover 204 of the handheld PC 100 is closed, as indicated by arrow 206 in FIG. 2, the LID module 02 remains visible and continues to display information and receive commands, even after the main display component 106 and many of the internal components of the handheld PC have been powered down. In one version of the handheld PC, a separate, low power processor, running a real time operating system, directly controls the LID module, using a minimal complement of low power devices that continue to operate following powering down of the high power processor, hard disk drive, main memory, and other internal components. The low power processor can receive basic commands through a low resolution, monochrome, touch-screen display 208 and a membrane keypad 210, and can display icons, such as the received email icon 212, to apprise a user of important events and information regarding the state of the handheld PC and information contained within the handheld PC.

The LID module, shown in FIG. 2, provides useful and convenient continuous information display but, in one version of the handheld PC, is implemented using a separate controller and additional software and hardware components, adding significant cost and potential reliability problems to the handheld PC. Furthermore, while the LID module is effective in extending minimal information display despite battery power-cycle constraints, the handheld PC is nonetheless primarily constrained by main-display-component power consumption. As the volume of a device decreases, the volume available for power storage also decreases, often at a greater rate than the overall decrease in the volume of the device, since the volumes of many standard, internal components are difficult to scale down. Moreover, heat dissipation problems are exacerbated as heat-producing components are packaged together at greater densities within smaller devices. For all of these reasons, designers and manufacturers of electronic, information-displaying devices, including handheld PCs, continually seek methods for more efficient power management with respect to information display and, more generally, for less expensive, simpler designs that avoid unnecessary use of specialized hardware and software to support particular features and components.

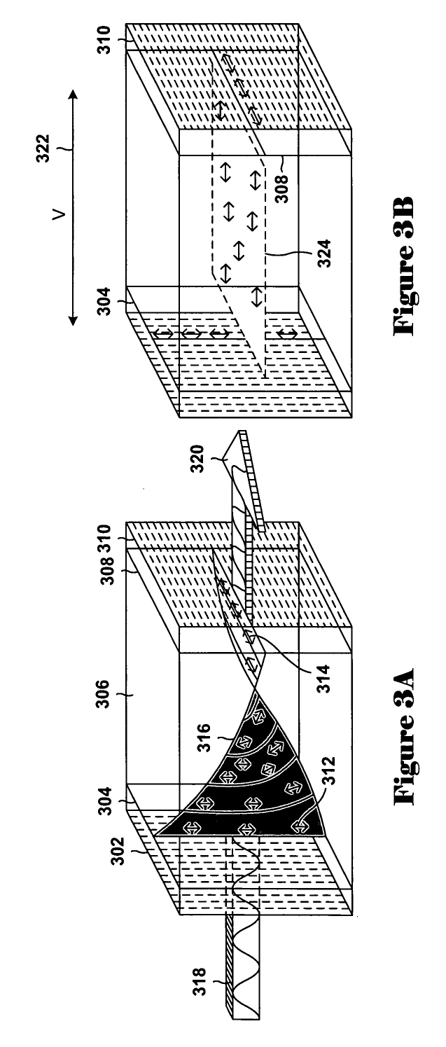

Currently, most handheld PCs and other portable electronic devices that include display components employ thin film transistor (“TFT”) active matrix (“AM”) liquid crystal display (“LCD”) devices. FIGS. 3A-3B illustrate the fundamental principle of operation of a single cell of a TFT AM LCD device. As shown in FIG. 3A, a cell of a TFT AM LCD device includes a number of different components: (1) a first birefringent polarizer 302; (2) a first cell wall 304 coated with brushed polyimide; (3) a matrix 306 containing a solution of relatively long, asymmetric liquid crystal molecules (“LCMs”); (4) a second cell wall 308 coated with brushed polyimide; and (5) a second birefringent, polarizer material 310 oriented 90° from the orientation of the first birefringent, polarizer material 302. The LCMs tend to align, at the surface of the cell wall, with the direction of the brushing of the polyimide coating. In the representative cell, shown in FIG. 3A, the brushing is vertically oriented on the inner surface of the first cell wall 304. Therefore, LCMs are also vertically oriented, as indicated by the vertically oriented double arrows, such as double arrow 312, along the inner surface of the first cell wall 304. The brushings on the inner surface of the second cell wall 308 are, in the representative cell shown in FIG. 3A, horizontally oriented. Therefore, the LCMs are horizontally oriented along the inner surface of the second cell wall 308, indicated by horizontally oriented double arrows, such as double arrow 314, in FIG. 3A.

The LCMs tend to self-aggregate with respect to at least one translational dimension, due to molecular interactions and to their inherent asymmetry. In the case of the representative cell shown in FIG. 3A, the LCMs tend to self-aggregate so that they have common orientations with respect to their longest dimensions, represented by the double arrows in FIG. 3A. Were the brushings on the inner surfaces of the cell walls both vertical, the LCMs throughout the matrix would all tend to have vertical orientations. However, because the brushings of the second cell wall 308 are rotated 90° from the orientation of the brushings of the first cell wall 304, and because LCMs tend to locally self-aggregate, the orientations of LCMs helically twist from vertical orientations near the first cell wall 304 to horizontal orientations near the second cell wall 308. In FIG. 3A, one plane of LCMs 316 is shown within the matrix. As can be seen in FIG. 3A, the plane is vertically oriented along the first cell wall 304 and twists into a horizontal orientation at the surface of the second cell wall 308, describing a portion of a helically twisted plane through the interior of the cell. The LCM solution is birefringent, with light polarized in a particular orientation with respect to the LCM orientation efficiently passed through the LCM solution, while light oriented 90° from that orientation is not transmitted through the LCM solution. Moreover, because of the helical twist of the orientations of the LCMs from the first cell wall 304 to the second cell wall 308, the polarization of light 318 entering the cell with a correct polarization for transmission is helically twisted 90° by the LCMs to emerge from the cell 320 with a polarization rotated 90° with respect to the incident polarization. Because, in the representative cell shown in FIG. 3A, the first birefringent layer 302 is oriented to pass vertically plane-polarized light, and because the second birefringent, polarization layer 310 is oriented to pass horizontally polarized light, the cell shown in FIG. 3A passes, with high efficiency, the incident, vertically oriented, plane-polarized light 318. However, as shown in FIG. 3B, when an electrical potential 322 is applied to the cell, the LCM molecules orient themselves in a particular direction with respect to the direction of the applied electrical potential. Thus, as shown in FIG. 3B, although the LCMs near the surface of the first cell wall 304 remain vertically oriented, and the LCMs near the inner surface of the second cell wall 308 remain horizontally oriented, the LCMs within the matrix are oriented with respect to the applied potential 322, as shown for an interior plane of LCMs 324 in FIG. 3B, rather than adopting the helical orientation via local self-assembly when not under the applied electrical potential, as shown in FIG. 3A. Because the LCMs do not exhibit the helically twisted orientation, in the cell shown in FIG. 3B, they do not twist an incident, vertically oriented, plane-polarized light to a horizontally, plane-polarized light at the opposite end of the cell. Because the second, birefringent, polarizer layer 310 is horizontally oriented, and because the incident vertically plane-polarized light is not helically twisted within the cell, none of the incident light emerges from the cell. A TFT AM LCD cell can therefore be electronically controlled to pass plane-polarized light with high efficiency, or to be essentially opaque to incident plane-polarized light, as shown in FIGS. 3A and 3B, respectively.

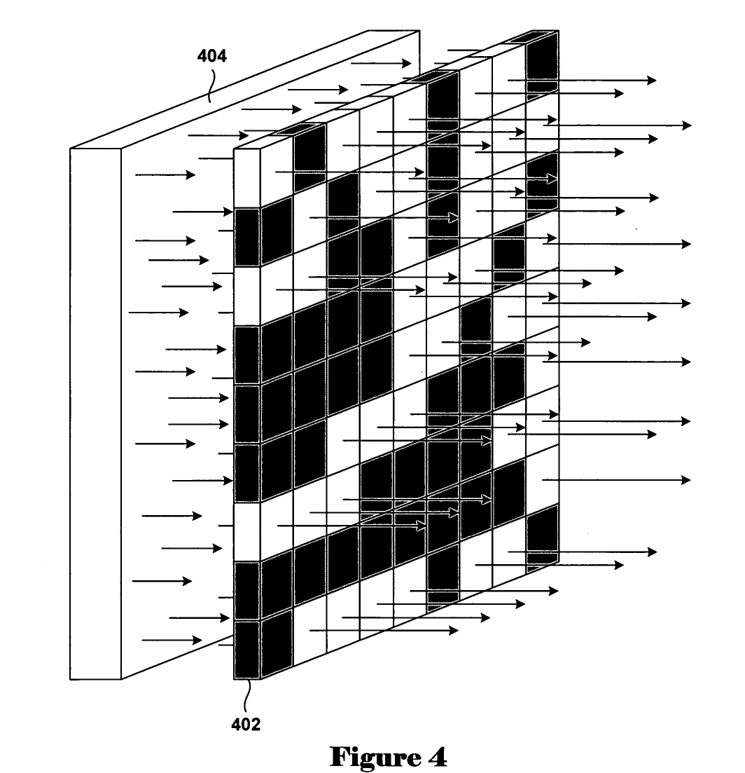

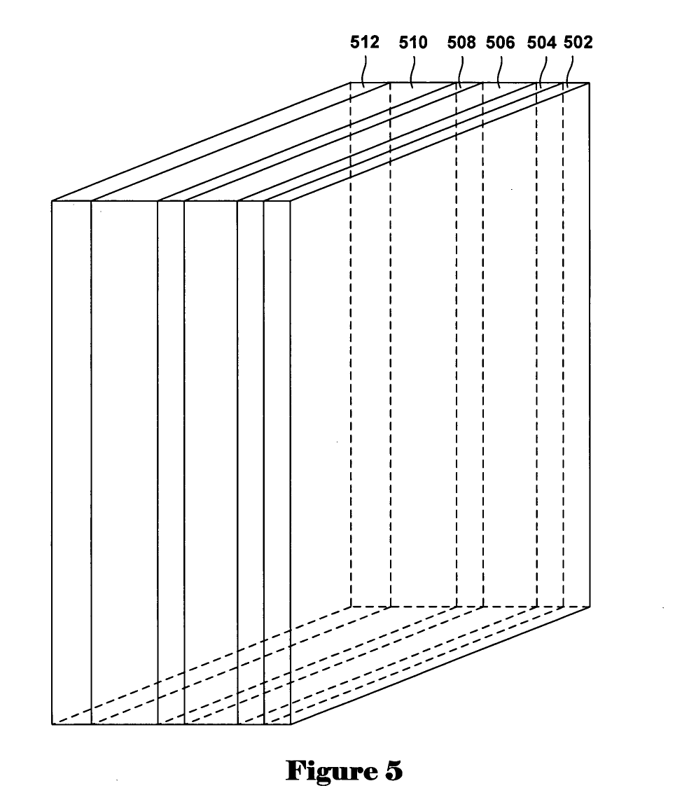

FIG. 4 illustrates operation of a TFT AM LCD display component. The birefringent, polarizer sheets and brushed cell walls are continuous layers enclosing a single, large LCM-containing matrix. Individual cells of the device, or pixels in a monochrome device, are delineated by small areas at which individual, separate voltages may be applied to the intervening matrix. Thus, the TFT AM LCD device is a flat, rectangular grid of cells 402 that can be independently, electronically controlled to either transmit plane-polarized light, or block transmission of plane-polarized light. A display component using TFT AM LCD technology requires a source of plane-polarized light 404 to provide the light, emission of which is controlled by the TFT AM LCD. In most currently available TFT AM LCD display components, the light source is a cold-cathode-fluorescent-lamp-based (“CCFL”) device. The lightness or darkness of a pixel is controlled by application of an electrical potential, with only a slight associated leakage current. Therefore, control of the pixel light-transmission states is a relatively low power operation. However, the backlighting source 404 must constantly emit light over the entire surface of the display component, and generally accounts for 70%-80% of the total power consumed by the display component. In other words, the backlighting source 404 emits light that falls both on light-transmitting cells as well as on light-blocking cells. LCD sources also suffer significant loss of light energy when the light emitted from LCD sources passes through polarizers. Diffuser elements are also generally needed, and the additional space needed for diffusers may be a significant impediment for decreasing screen sizes for smaller devices. In a TFT AM LCD display components, power consumption is relatively constant and relatively high, regardless of the information being displayed by the display component. In fact, power consumption is slightly higher for an opaque, all black display screen than for a white, fully transmissive display screen. A TFT AM LCD display may also use a white light, LED light source, but power-consumption efficiencies are similar to those for devices using CCFL light sources.

Recently, a new type of display technology has been developed. This display technology is based on organic-light-emitting-diode materials incorporated into organic-light-emitting devices (“OLEDs”). FIG. 5 shows layers of a typical OLED. The layers include: (1) a transparent substrate; (2) a transparent anode 504, often an indium tin oxide layer; (3) a hole transport layer (“HTL”) 506, an organic-polymer layer that inherently, or via doping, exhibits relatively high mobilities for positive charges, such as N,N′-diphenyl-N,N′-bis(3-methylphenyl) 1-1′biphenyl-4,4′diamine (“TPD”); (4) a light-emitting layer (“EML”) 508, such as tris(8-hyroxyquinoline) aluminum (“AlQ₃”), in which excited electrons occupying normally unoccupied molecular orbitals combine with holes to produce excitons that decay, via emission of visible light, to lower energy states; (5) an electron transport layer 510 (“ETL”), an organic polymer layer that, inherently or via doping, exhibits a high mobility for electrons; and (6) a cathode layer 512, such as a metallic or organic polymer, conducting film. These six layers form an extended, two-dimensional pn junction, each volume element of which, extending from the substrate layer 502 to the cathode layer 512, comprises a light-emitting diode. When a light-emitting diode is forward biased, by application of an electric potential perpendicular to the plane of the layers shown in FIG. 5 with the more electronegative side of the potential applied to the cathode layer 512, electrons from the ETL 510 combine with holes from the HTL 506 in the EML 508 to emit light.

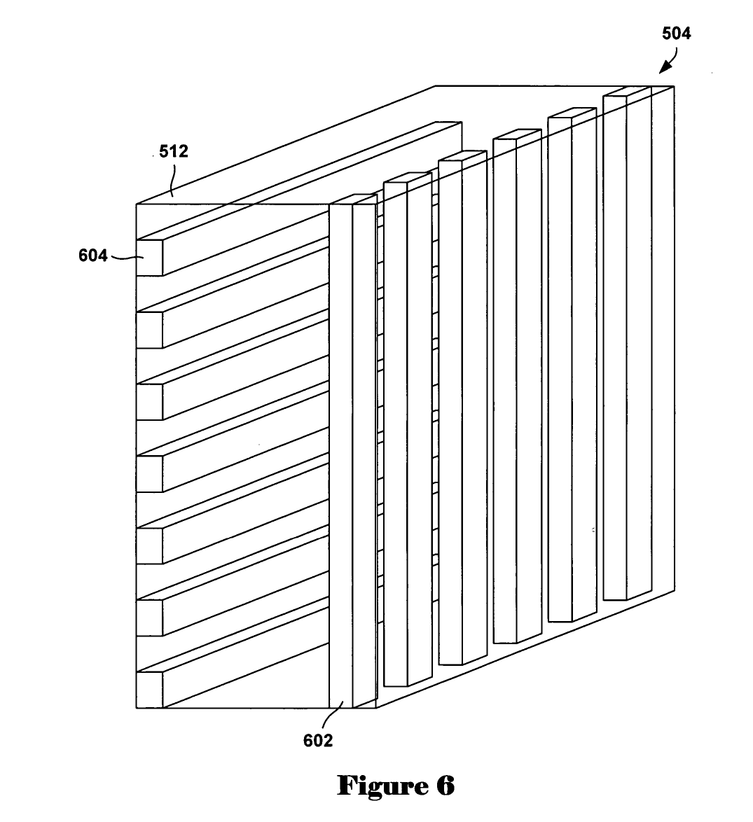

FIG. 6 shows anode columns and cathode rows in one type of OLED material. In FIG. 6, details of the transparent anode 504 and cathode 512 layers of the OLED shown in FIG. 5 are illustrated. As shown in FIG. 6, the transparent anode layer 504 comprises a series of electrically isolated columns, such as column 602. The cathode layer 512 comprises a series of electrically isolated rows, such as row 604. An electric potential may be separately applied to each anode column and cathode row.

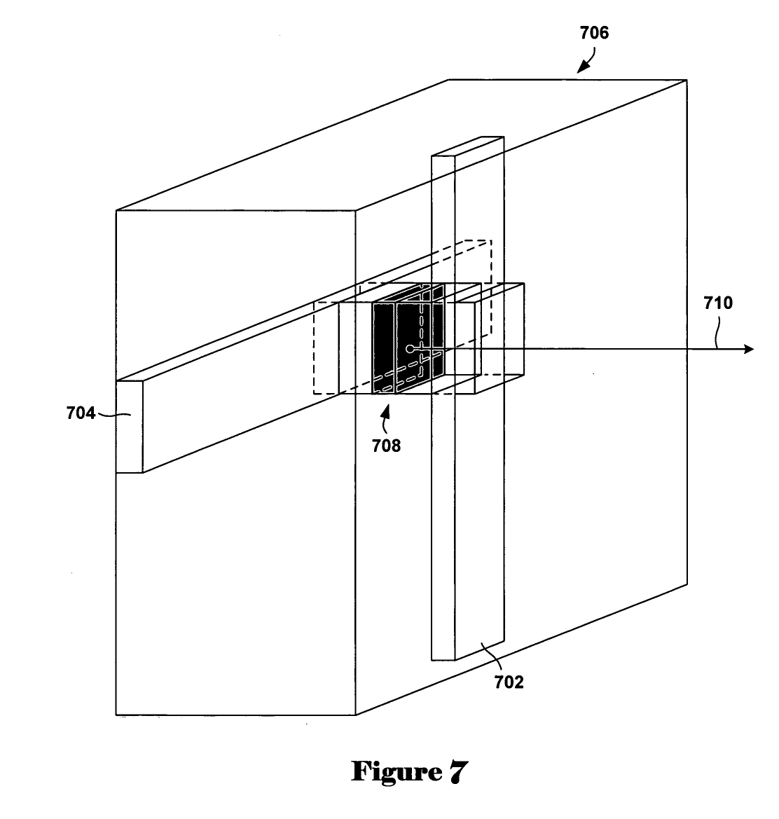

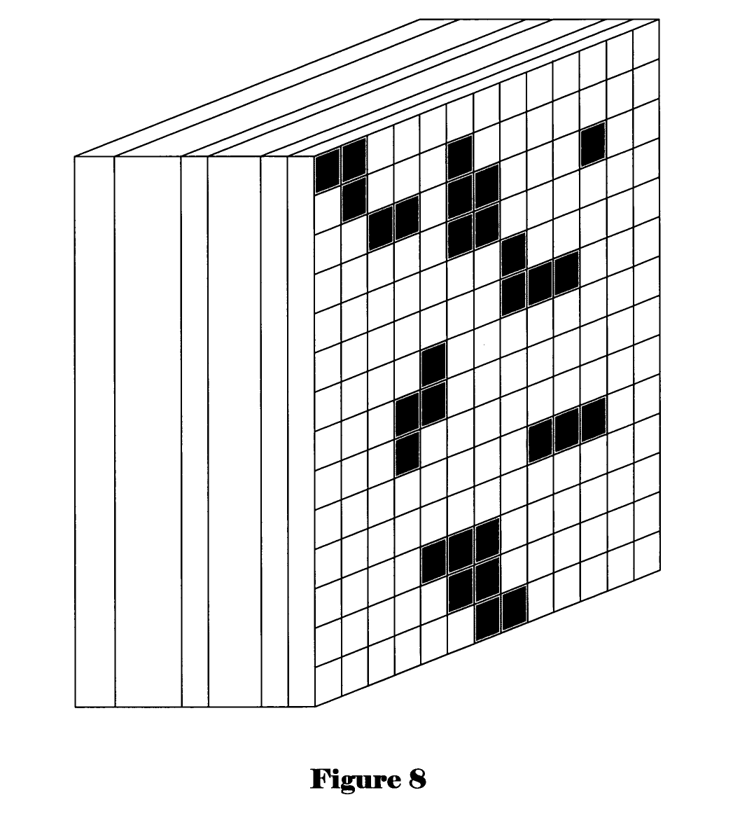

FIG. 7 illustrates a single cell within the OLED shown in FIGS. 5 and 6. In FIG. 7, a single anode column 702 and cathode row 704 are shown within a small volume 706 of the OLED. When a positive voltage V₊ is applied to the anode column 702 and a negative voltage V₋ is applied to the cathode row 704, a voltage differential of 2V is applied to the volume element 708 of the OLED overlapped by, and between, the anode column 702 and cathode row 704. The voltages are chosen so that an applied voltage of 2V results in sufficient forward biasing of the photodiode represented by the volume element 708 to produce sustained emission of the light, represented by arrow 710 in FIG. 7. The other volume elements overlapped by either one, but not both, of the anode column 702 and cathode row 704 experience an applied voltage of V, chosen to be below the threshold for stimulation of light emission.

FIG. 8 shows a rectangular grid of pixels on the surface of a portion of an OLED. As shown in FIG. 8, by selectively applying voltages, in a time-dependent fashion, to the anode columns and cathode rows of the OLED, any arbitrary pattern of illumination within the cells formed by overlap of the anode columns and cathode rows can be produced.

An OLED-based display component has very different power consumption characteristics than the previously described TFT AM LCD display component. First, while the TFT AM LCD display component has relatively constant and high power consumption regardless of the transmission state of the cells, due to the overwhelming proportion of power consumed by the backlighting source, only those cells currently emitting light in an OLED display device consume power, and the power consumption of a light-emitting cell is proportional to the intensity of the emitted light. The OLED display device is one example of a direct light-emission display component, in which light is directly emitted from the material, in response to an applied signal, rather than being emitted by a light source behind an electrically controlled light-transmission medium. Moreover, OLED materials can be produced with extremely high quantum efficiencies for conversion of electrons to light. They may therefore exhibit an overall lower power consumption than a display component depending on a backlighting source, although in many current OLED materials, the relatively high resistance of the organic polymer layers offsets the quantum efficiency of light generation. However, for all direct light-emitting materials, such as OLEDs, a dark, black screen consumes almost no power. A fully lit, white screen, by contrast, maximally consumes power. In other words, the power consumption of a direct light-emitting-material-based display device is directly proportional to the amount of display-component real estate that is currently emitting light, and the intensities of the emitted light. Darker regions consume less power, and black regions consume almost no power.

OLED-based display components, which are one type of direct-light-emitting-material-based (“DLEMB”) display components, have only recently become commercially available in sizes, and at costs, suitable for use in the main display component of a handheld PC or other information-displaying electronic appliance. Therefore, the power-consumption characteristics of DLEMB display components have, as yet, not been exploited in the design of handheld PCs and other electronic, information-displaying appliances. By decreasing the time-averaged area of the display screen that is illuminated for the display of textual and graphical information, for example, the power consumption of a DLEMB display component can be correspondingly decreased. In other words, as the percentage of time that any given region of a DLEMB display component emits light is decreased with respect to the total time DLEMB-display-component operation, the time-averaged power consumption for that region decreases. As discussed above, a similar strategy would, in general, provide no decreased power consumption for a traditional TFT AM LCD display component, and may actually increase power consumption.

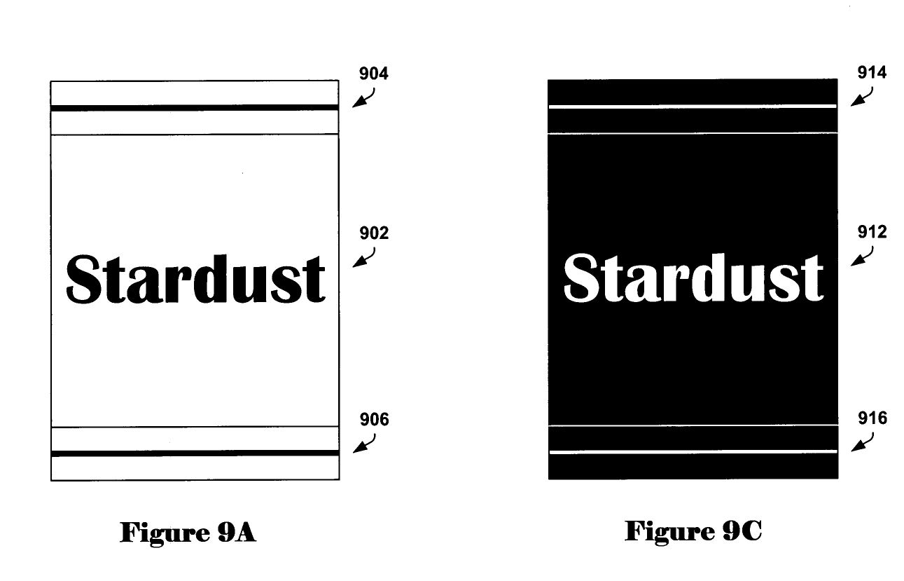

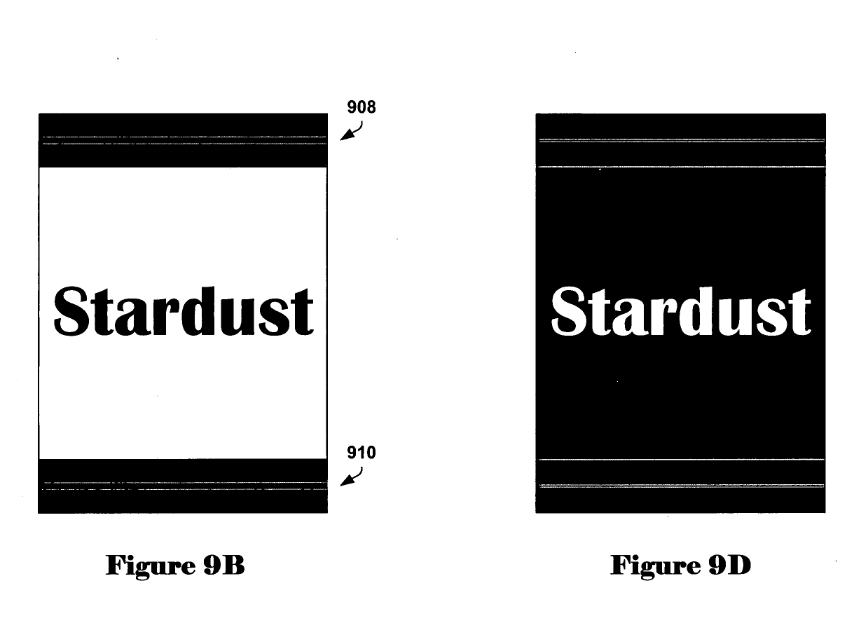

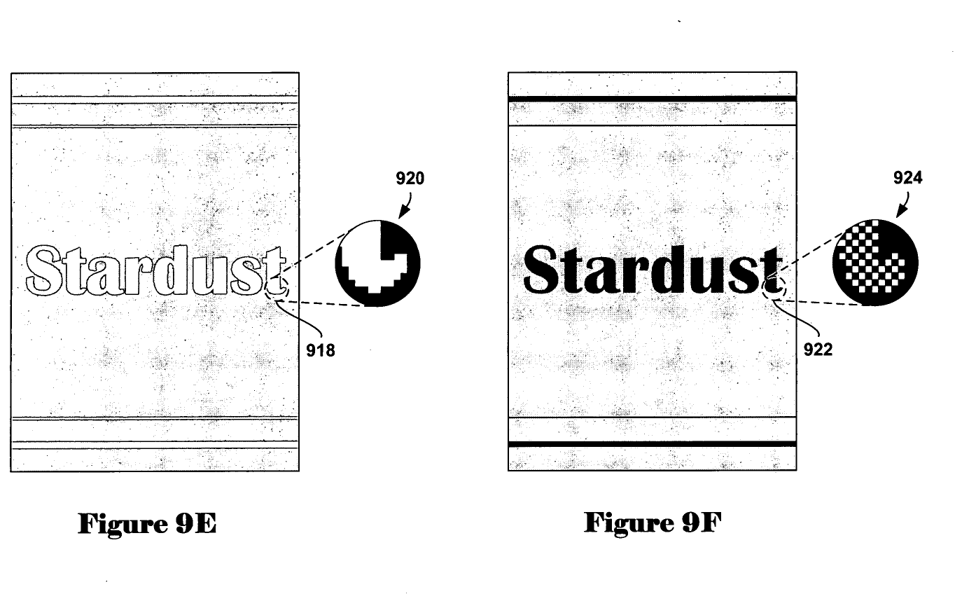

FIGS. 9A-F illustrate power-consumption-decreasing methods that represent embodiments of the present invention. FIG. 9A shows a simple graphic displayed on a DLEMB display component. The graphic shown in FIG. 9A includes a large font display of the word “stardust” 902, a stylized upper border region 904, and a similar, stylized lower border region 906. Most of the graphical display consists of a white background, such as the white background commonly employed for many PC-based applications, including Microsoft® Word. As discussed above, for a DLEMB display component, the power consumed in displaying the graphical image shown in FIG. 9A is relatively high. One approach to decreasing the power consumption for displaying a graphic containing the same information, shown in FIG. 9B, is to replace the stylized upper and lower borders (904 and 906 in FIG. 9A) with darkened borders 908 and 910, respectively. No information is lost in this transformation. For example, the Microsoft® XP operating system allows for configuration of the colors or standard display features, such as window borders, backgrounds, and other standard display features. If Windows® XP is configured to use dark window borders, backgrounds, and other display features, the power consumption for displaying the features may be significantly decreased.

FIG. 9C illustrates another power-consumption-decreasing method for displaying the graphic shown in FIG. 9A. In FIG. 9C, dark and light regions of the image have been reversed. In other words, FIG. 9C is a negative image, with respect to color, of the original graphical image shown in FIG. 9A. The text 912 and upper and lower stylized borders 914 and 916 in the negative image are identical, in shape, form, and information content, to the corresponding text 902 and borders 904 and 906 in the original graphic shown in FIG. 9A. However, because the bulk of the screen area is dark, in the negative image shown in FIG. 9C, the power consumption for displaying the negative image shown in FIG. 9C is a small fraction of the power consumption needed to display the original image shown in FIG. 9A. Again, Windows® XP and other operating systems allow for configuration of foreground and background colors. For example, Windows® XP can be configured so that the Microsoft® Word application displays text as white characters on a black background. When configuration through an operating system is not possible, manipulation of the display hardware and display firmware may be used to achieve the same effect.

An even less-power-consuming version of the original graphic, shown in FIG. 9A, is shown in FIG. 9D. In this version, the foreground/background coloration has been reversed, as in FIG. 9C, and the stylized upper and lower borders (904 and 906 in FIG. 9A) have been entirely darkened.

To even further decrease power consumption, the displayed text may be displayed at lower, average intensity by dithering the pixels within the displayed text. FIGS. 9E-F illustrate dithering of displayed text and images in order to decrease power consumed for the display. In FIG. 9E, the text and features displayed in FIG. 9C is again shown, with a small circled portion of a displayed character “t” 918 magnified to show individual pixels in the region 920. The pixels within the character “t” are all light colored, while background pixels are darkly colored. Power consumption can be decreased by dithering the displayed text. In one embodiment, every other pixel in the displayed text is dark, forming a checkerboard-like pattern of light and dark pixels. Dithering may also be viewed as decreasing the resolution of displayed images, increasing the graininess of the display, or as choosing a darker display of text and features on a grayscale between white and black.

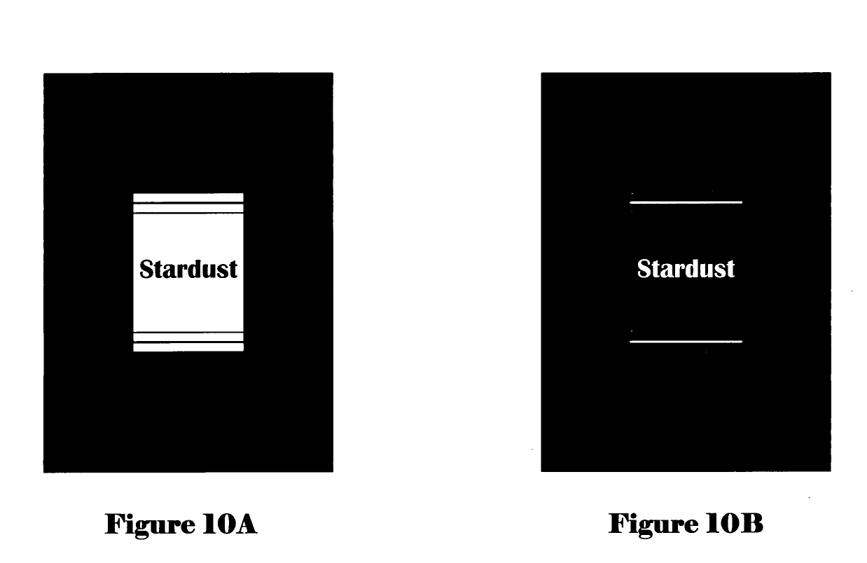

Another technique for increasing the non-light-emitting portion of the display screen is to decrease the size of display windows and display them on a black background. FIGS. 10A-10B show the graphics of FIGS. 9A and 9C, respectively, at one third their original sizes, centered on a black background. No information has been removed, and the appearance of the information has not been changed, in decreasing the window size from full size, shown in FIG. 9A, to one-third size, shown in FIG. 10A. Thus, another technique for increasing the non-light-emitting portion of the display screen is to simply decrease the sizes of displayed objects.

In addition to increasing the average portion of the display screen dark that is dark, power consumption can also be decreased by displaying primary colors produced by activating a single layer of a multi-layer direct light-emitting material in light-emitting regions of the display screen, rather than colors produced as combinations of light of different wavelengths produced by activating two or more layers of a multi-layer direct light-emitting material. In a three-layer direct light-emitting material, display of a region in a primary color represents activation of a single layer within the region, with the other two layers essentially dark. Disregarding intensity, display of a primary color therefore represents a first incremental increase in power consumption above a dark display screen, with a second incremental increase represented by display of a color formed by combining two primary colors, and a third incremental increase represented by display of white light, for which all three layers of a three-layer direct light-emitting material are activated. As with other power-consumption-decreasing techniques, a preference for display of primary colors also serves to extend the usable lifetime of a direct light-emitting display by decreasing the proportion of total display-operation time during which each layer emits light.

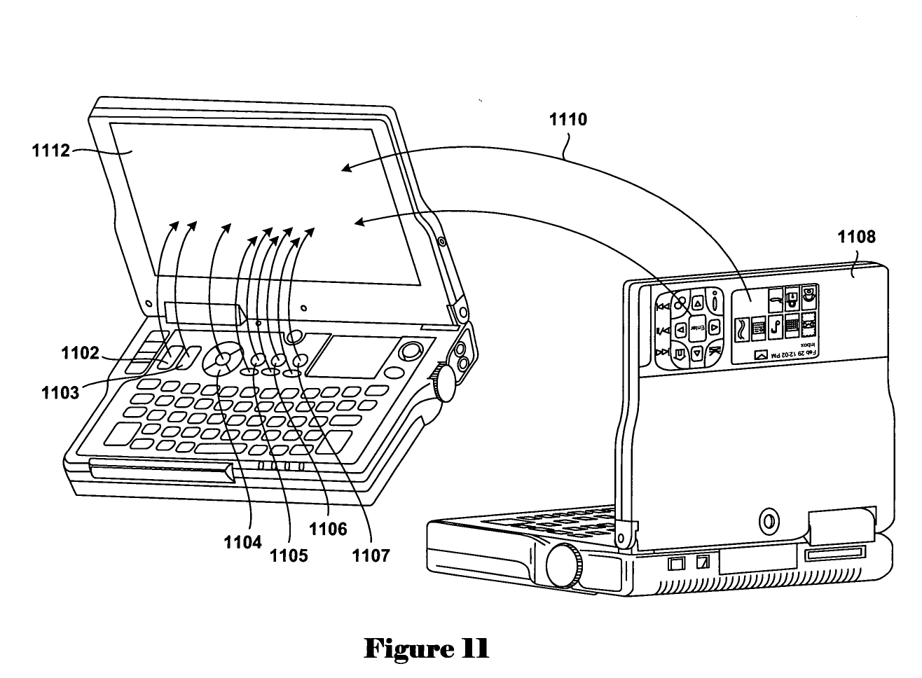

Decreasing power consumption by configuring, within an electronic appliance, display modes that increase the amount of non-light-emitting real estate on a display screen, whether by reversing foreground/background color configurations, darkening or blackening stylized borders and features, decreasing display-window sizes, or preferentially displaying primary colors, can greatly decrease power consumption of the display component and correspondingly increase the operation cycle times for energy-storing components, such as batteries, in a portable device. However, the power-consumption characteristics of DLEMB display components allow for additional efficiencies in the design of handheld PCs and other electronic devices. FIG. 11 illustrates incorporation of separate components in displayed components on the main display component of a handheld PC. The keyboard of the handheld PC may include a number of key devices and areas 1102-1107 that are illuminated with LED devices either permanently, for easy identification by a user, or intermittently, to call a user's attention to various machine states. These separately illuminated features require separate and relatively expensive wiring and other hardware/firmware/software support. As discussed above, one version of the handheld PC additionally includes, on the back of the cover, a low power-consuming LID module 1108. In an additional embodiment of the present invention, as indicated by the arrows in FIG. 11, such as arrow 1110, the separately illuminated keys and LID module may be both moved to the main display component 1112. This is possible for a DLEMB display component because, when the LID module and separately illuminated keys together make up only a small fraction of the total display-screen real estate of the main display component, the separately illuminated keys and LID module may be continuously displayed with low power consumption. Scan frequency may be decreased to further decrease power consumption when the device is not in use, with the scan rates restored to normal rates when user input is again detected. Note that, in the currently available handheld PC, with a common TFT AM LCD main display component, the strategy illustrated in FIG. 11 would not be desirable, since the main display component, which consumes a large amount of power regardless of the portion of the screen emitting light, would need to be continuously operated. Moving the illuminated keys and LID module to the main display component both eliminates costly and potentially unreliable specialized implementations of these features, and also provides for full color, high resolution display of the LID module. In order to provide convenient access to the LID module during low power states of the handheld PC, a PC-tablet-type configuration may be employed so that the main display screen is visible both when the cover of the handheld PC is open and when the cover is closed. Alternatively, a flip convertible tablet solution may be employed.

A touch-key panel displayed on the main display component may allow for manual activation of higher power-consumption modes by users, or may trigger automatic activation of higher power-consumption modes. For example, both display intensity and display color schemes may automatically lapse to low power-consumption modes following a period of user inactivity, in order to conserve energy. These low power-consumption modes may include primary color, low intensity display of minimal information. A higher power-consumption display mode may be explicitly invoked by a user touching a wake-up button on the touch-key panel. Alternatively, any user input may result in a transition to higher power-consumption display modes, such as full screen, white background, high intensity display of a current machine and operating system state.

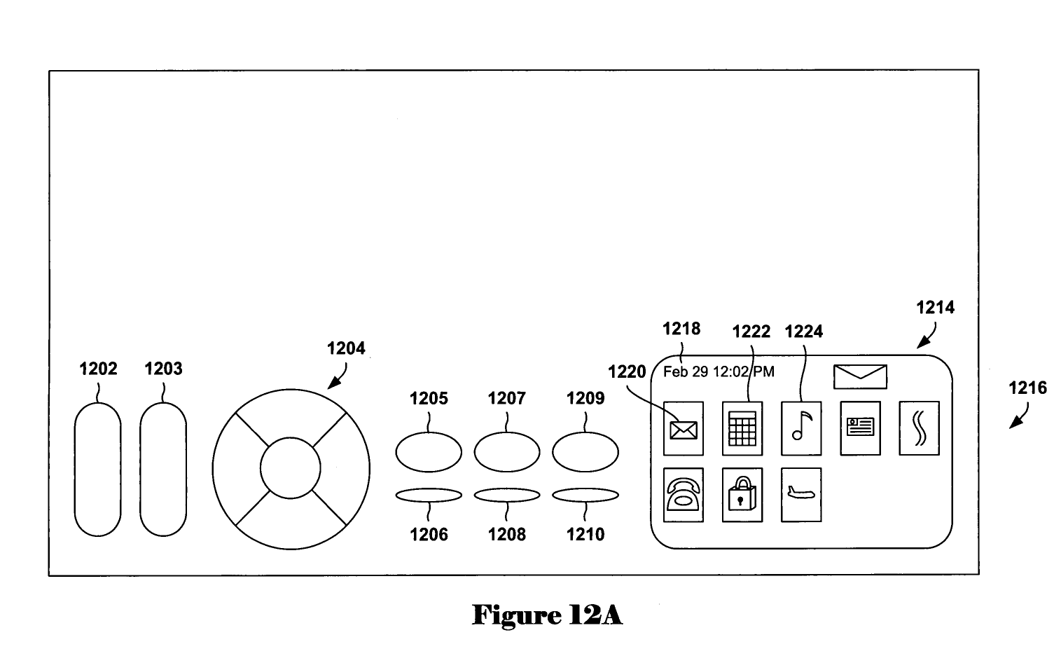

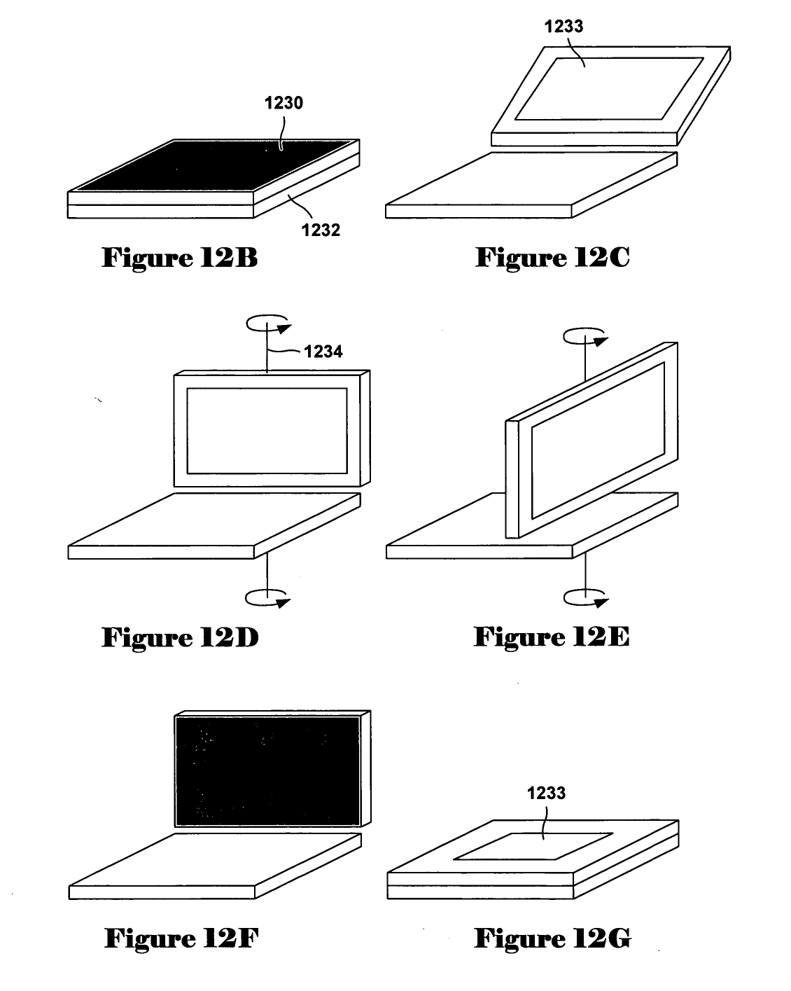

FIG. 12A shows an example of low power-consuming display of separately illuminated keys and a portion of the LID module. Because the display of the separately illuminated keys 1202-1210 and LID module 1214 uses only a relatively small portion of the total size of the display screen 1216, power consumption is low. Of course, the sizes of the displayed, separately illuminated keys 1202-1210 and LID module 1214 may be further decreased to further decrease power consumption. In one embodiment, the LID module may include time and date information 1218 and various icons for invoking specific low power applications, including a low power email icon 1220, a low power calendar icon 1222, and a low-power audio-player icon 1224. The displayed keys may include a keypad 1204 with directional keys 1226-1229 and an enter key 1230 that allow for menu selection and other application-defined user input. The display colors may be restricted to primary colors in order to further decrease power consumption. Moreover, these continuously displayed objects may be moved about the display screen in order to average light emission over all portions of the screen. Otherwise, the continuously light-emitting portions of the DLEMB display component may tend to degrade to a greater degree, over time, than the remaining portions of the DLEMB display component.

FIGS. 12B-G show a preferred embodiment for low power-consuming display of the LID module and various separately illuminated keys. In the preferred embodiment, the display screen of a portable device is both foldable and rotatable. As a result, the display screen can be positioned in closed position, facing inward, for protection, and can also be position in a closed position facing outward, to allow for display of information and user interaction. FIG. 12B shows a portable electronic device in a closed position, with a display screen facing inward, and not externally visible. The portable electronic device includes a cover 1230 and a body 1232. The cover 1230 includes a display screen, and the body includes a keyboard, with the processor, memory, disk drives, and other electronics contained within the body. The portable electronic device can be manually opened to reveal the display screen 1233, like laptop and notebook computers, as shown in FIG. 12C. The cover is hinged so that the cover is rotatable about a bisecting rotation axis, in addition to being hinged along a rotation axis along a lower edge, permitting clamshell-like opening, as shown in FIG. 12C. FIG. 12D shows the bisecting rotation axis. The bisecting rotation axis 1234 is vertical when the cover is positioned vertically. The cover can be rotated 180° about the bisecting rotation, as shown in FIGS. 12E-F, and then closed in clamshell-like fashion, so that the display screen 1233 is externally visible, as shown in FIG. 12G.

The various power-consumption-decreasing methods discussed above with respect to FIGS. 9A-D and 10A-B may be applied in a relatively static, constant manner, or may be applied dynamically, as the amount of remaining energy in energy-storing components of a portable electronic appliance decreases past one or more thresholds. Initially, for example, the handheld PC or other portable electronic appliance may provide a user interface by which a user can select various power-consumption-decreasing display configurations, depending on the user's tastes and the user's need to run the portable electronic device for long periods of time on internally stored energy. The user may also select various power-consumption-decreasing strategies that are automatically invoked during operation of the electronic appliance as the amount of stored energy decreases. For example, a user may choose to configure touch-screen capabilities, display colors, light-sensor thresholds, and employ other power-consumption-decreasing strategies, in addition to selecting window sizes, display intensity, and the omission of display-features.

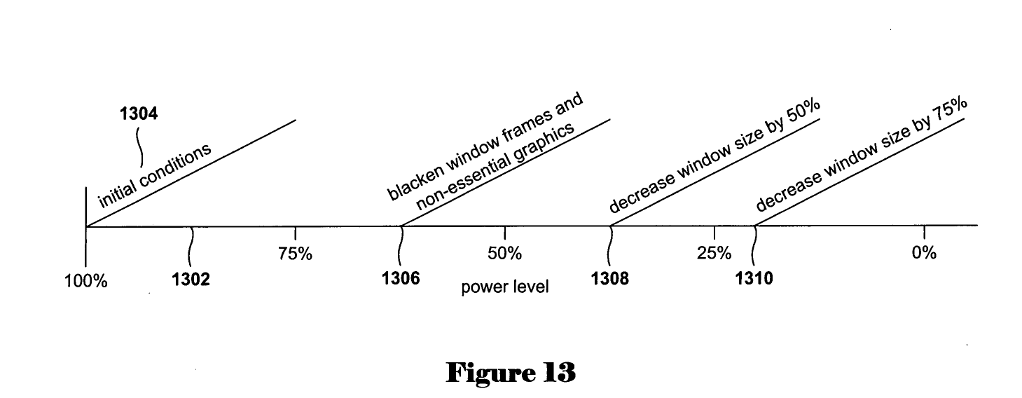

Different methods may be employed to configure an electronic appliance for staged invocation of different power-consumption-decreasing display strategies. FIG. 13 illustrates an example discrete, power-consumption-decreasing strategy. In FIG. 13, the amount of energy remaining in energy-storing components of a portable electronic appliance is represented by a horizontal axis 1302. Points at which various power-consumption-decreasing display techniques may be invoked automatically are selected along the horizontal axis. For example, in FIG. 13, a set of initial conditions, or parameters is specified for a remaining stored energy level of 100% 1304 extending down to approximately 60% 1306. At approximately a 60% remaining stored energy level, a display technique in which window frame borders and other nonessential graphical features are blackened is invoked. When the stored energy level decreases to approximately 35% 1308, the additional display technique of decreasing window sizes by 50% is invoked. Finally, when the remaining stored energy level decreases to about 20% 1310, the window sizes are decreased by 75% from the original window sizes. The handheld PC may provide a user interface to allow a user to select the different power-consumption-decreasing display techniques, along with initial default display techniques, to be invoked at user-defined stored energy levels. Otherwise, the handheld PC may employ a default power-consumption-decreasing strategy, such as the strategy shown in FIG. 13.

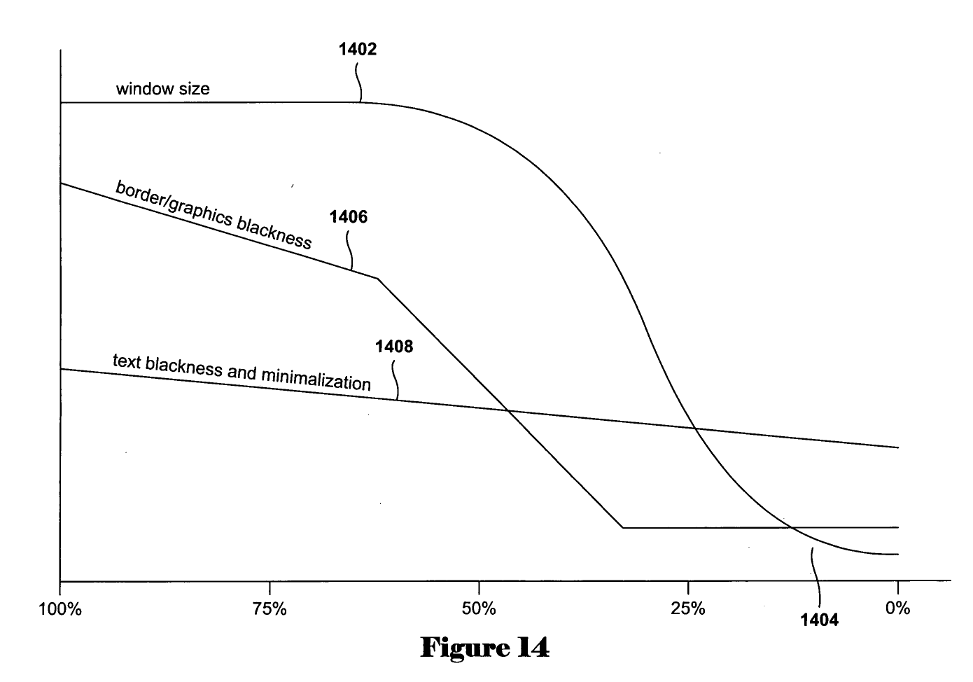

Alternatively, the power-consumption-decreasing strategies may be parameterized to produce quasi-continuous functions with respect to stored energy level. FIG. 14 illustrates quasi-continuous, paramterized power-consumption-decreasing strategies. As shown in FIG. 14, the size of displayed windows remains fixed at an initial, default size until the remaining stored energy drops to slightly above 50% 1402, at which point the window sizes are continuously and precipitously decreased as remaining stored energy drops to below 20% 1404. Similarly, the extent to which window borders and other stylized graphical conventions are eliminated, by blackening or darkening, as represented by curve 1406, increases as the remaining storage energy decreases. Similarly, the degree to which the background for displayed text is darkened may be slowly increased with a decrease in remaining stored energy, as represented by curve 1408 in FIG. 14. Thus, finely grained degrees of background darkening, display-size minimization, and unnecessary display-feature elimination may be progressively increased as the stored energy remaining in the energy-storing components of a portable electronic device decreases, and may be straightforwardly parameterized using simple mathematical functions.

In either the discrete, power-consumption-decreasing strategy discussed with reference to FIG. 13, or the parameterized, quasi-continuous-power-consumption decreasing strategy discussed with reference to FIG. 14, additional power-consumption-decreasing techniques may be included, such as eliminating display of non-primary colors, inverting light and dark display regions to increase the proportion of dark display regions, changing the scan rate, and other techniques. FIGS. 13 and 14 show representative invocation points for individual, power-consumption-decreasing techniques for the sake of illustration clarity.

As an alternative to monitoring stored energy remaining in the device for the purpose of invoking various power-consumption strategies, as discussed above with reference to FIGS. 13 and 14, the brightness of the screen may be monitored during usage by a built-in light sensing device and integrated with respect to time to determine when different power-consumption/screen-lifetime-preserving functions should be invoked. In particular, over extended periods of time, a gradual deterioration in the direct light-emitting material may be tracked, and, in addition to invoking screen-lifetime-preserving function, the relative intensities at which different layers of a multi-layer direct lighting-material are activate to emit light may be altered to compensate for non-uniform degradation of the various different light-emitting layers. In an additional embodiment, the various power-consumption/screen-lifetime-preserving functions may be invoked based on elapsed time.

Alternatively, rather than automatically invoking low power-consumption modes, a user may select one or a combination of low power-consumption modes via keys or touch-screen keys that control display modes, through a menu system, or by explicitly typing and entering display-mode commands. User selection prior to automatic invocation of low power-consumption display modes may further increase energy conservation.

Various portable electronic appliances may include an ambient light sensor that allows the average ambient light energy and average ambient light frequency to be determined continuously during operation of the electronic device. An ambient light sensor allows for the display intensity to be modified according to ambient light conditions, in order to display intensity appropriate for a user's environment. Display-intensity modification may include an overall intensity modification, and may also include changing the display intensity for various portions of the display spectrum, in order to adjust the displayed colors to the ambient light frequency of maximum intensity. Various portable electronic appliances may also include a manual switch, to allow a user to adjust overall intensity depending on whether or not the electronic appliance is operating on a portable stored energy source, and also depending on the user's perception of ambient light intensity and corresponding readability of the information displayed on the display screen.

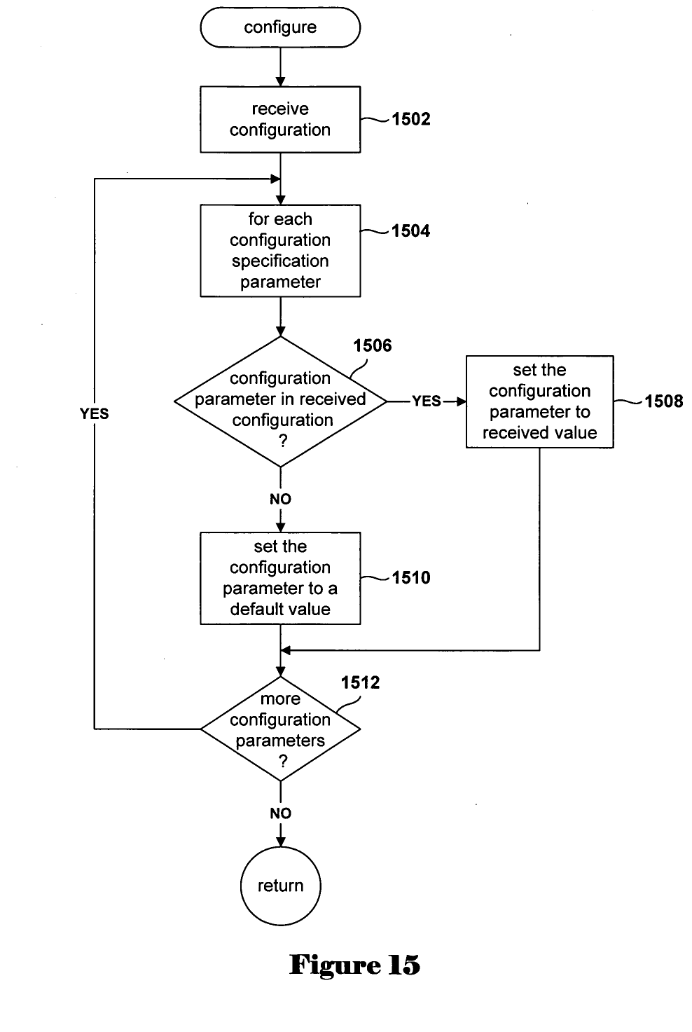

FIG. 15 is a control-flow diagram of a configuration routine that configures an electronic, information-displaying device to operate in a low power-consuming display mode. In step 1502, the configuration routine receives a list of configuration specifiers, including configuration parameters. The list of configuration specifiers may be supplied from a previously prepared configuration file, may be generated by a user-interface displayed to receive a user-supplied configuration, or may be supplied from internal flash memory or other hardware components. In general, configuration parameters include the identities and arguments to be supplied to system routines for configuring an operating system, although additional types of configuration specifiers may be included, such as the identities and arguments of BIOS routines. In certain cases, application of the configuration specification parameters may be deferred until an operating system reboots, or the electronic appliance is restarted. In most cases, the configuration specifiers relate to operating-system-provided system calls, and can be immediately applied. Display mode configuration is operating-system dependent, and different operating systems provide different application programming interfaces to allow for programmatic display-mode configuration. The Microsoft XP® operating system also provides an graphical user interface to allow a user to manually configure display modes, accessible through the appearance option if the display preferences menu invoked by a right click input to the desktop.

In the for-loop of steps 1504-1512, an operational mode or characteristic of the electronic appliance is set for each aspect of configuring low power-consumption display of information in the electronic, information-appliance. If the aspect corresponds to a configuration specifier provided in the received list of configuration specifiers, then the provided configuration specifier is used to set the operational mode or characteristic, generally via a system call, in step 1508. Otherwise, the operational mode or characteristic corresponding to the currently considered configuration aspect is set to a default value in step 1510.

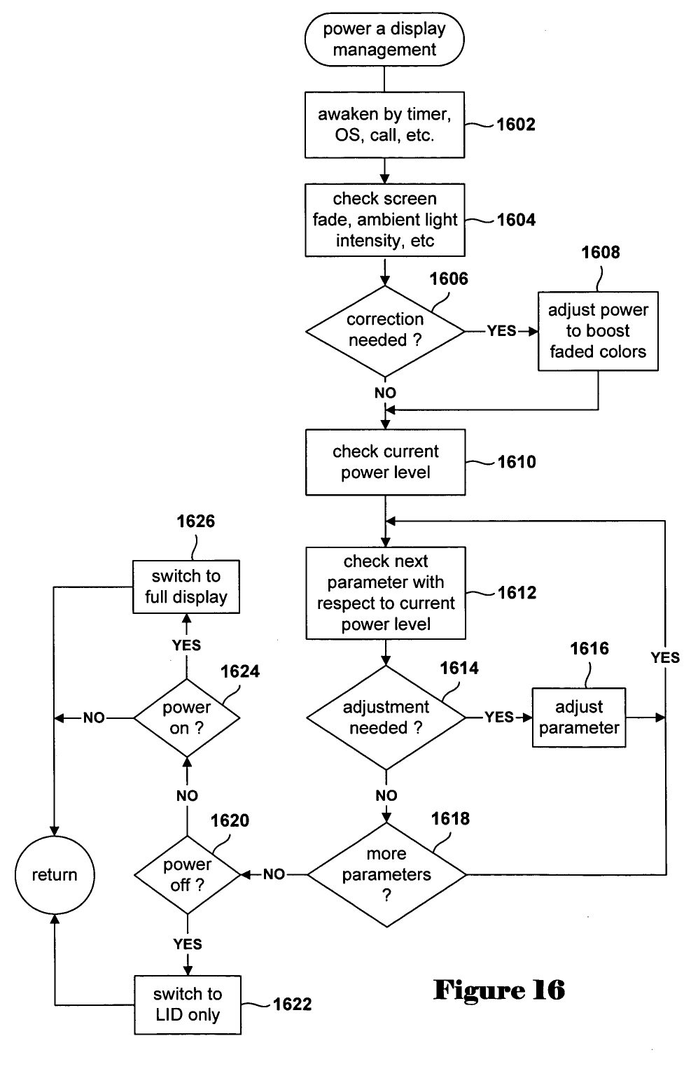

When the for-loop completes, the electronic, information-displaying device is configured for an initial low power-consumption display mode. However, as the device is operated, additional power-saving display modes may need to be invoked. FIG. 16 is a control-flow diagram of a power-management routine that may be periodically invoked by firmware or by an operating system running on an electronic appliance to manage power consumption by a DLEMB display component according to various embodiments of the present invention. In step 1602, the power-management routine is awakened by a timer, by invocation by an operating system routine, or by other, similar means. In step 1604, the power-management routine first checks the extent to which the light-emitting material of the display component has degraded, as well as for ambient light intensity, if an ambient light sensor is present, and for any user-supplied indications of the need to adjust display intensity, such as user input to a switch to control display intensity. As discussed above, regions of direct light-emitting materials degrade over time, often in direct relation to the amount of time during which light has been emitted from a region of the display component and in direct relation to the intensity of light emitted. A power-management routine may compensate for this direct light-emitting-material degradation by increasing voltage potentials or other signals employed to drive light emission for various regions of the display component. A power-management routine may apply a fixed formula for well known degradation characteristics, using stored information characterizing the amount of time and the intensities at which light has been emitted from display-component regions, to determine the amount of degradation experienced by those regions. Alternatively, devices may be included in the electronic appliance, such as photosensors or other devices, to directly monitor the light intensity emitted by various regions of the screen at different applied voltages. As discussed above, the electronic appliance may include ambient light sensors to allow for adjusting display intensity in accordance with environmental conditions, and may also include an input device to allow a user to manually adjust display intensity. If, in step 1606, the power-management routine determines that degradation in the direct light-emitting materials has occurred with respect to a previous point in time, determines that the display intensity needs to be adjusted because of ambient light intensity and frequency, and/or determines that a user has input a desire to change display intensity, the power-management routine, in step 1608, may adjust the voltage or other signal applied to various regions of the screen to change display intensity. It should also be noted that the display degradation may occur unevenly with respect to different portions of the spectrum of emitted, colored light. In such cases, an adjustment may be separately carried out for each of the different layers, or subpixels, corresponding to different portions of the spectrum. For example, display of blue often deteriorates most rapidly, and adjustment may be made to slowly increase the emission of layers that contribute to blue display according to a blue-display-deterioration formula. In addition, a preference for non-blue display of information, when a choice is possible, may lengthen the lifetime of the display component.

Next, in step 1610, the power-management routine checks the current level of stored energy within an energy-storage component of the electronic appliance. Separately considering each type of power-consumption-decreasing strategy, such as the different power-consumption-decreasing strategies discussed with respect to FIGS. 13 and 14, the power-management routine checks to determine whether the currently considered strategy or technique needs to be invoked or increased based on the determined, current, remaining stored energy level, in step 1612. If adjustment is needed, as determined in step 1614, then the power-management routine adjusts the parameter in step 1616. For example, the power-management routine may determine that, with respect to the scheme illustrated in FIG. 13, the remaining stored energy level has fallen from above 60%, when last checked, to below 60% currently, and that, therefore, window-frame borders and other nonessential graphics need to be blackened at this point in time. Alternatively, in the scheme shown in FIG. 14, the power-management routine may more finely adjust application of the various power-consumption-decreasing strategies at each interval, for example, increasing the number and types of display features blackened as the remaining stored energy levels continue to decrease. Furthermore, the routine may check for user invocation of power-consumption-decreasing strategies, including restricting display colors, decreasing window sizes, omitting certain displayed features, eliminating background pictures, lowering display intensity, lowering the scan rate for the display, and other similar strategies. Various embodiments may differ in the power-consumption-decreasing strategies that are automatically invoked, user invoked, and/or invoked both by users and automatically.

When no additional parameters need to be considered for adjustment, as detected in step 1618, the power-management routine checks, in step 1620, whether a power-off condition has occurred. If so, then in step 1622, the power-management routine may configure the electronic appliance to display only the LID module and other continuously displayed features in step 1622. Otherwise, the power-management routine may check, in step 1624, whether a power-on has occurred in the interval since the power-management routine last ran. If so, then the power-management routine may configure the electronic appliance to support full use of the display screen, in step 1626. In alternate embodiments, power-off and power-on sensing and display-component configuration may occur in other portions of the operating system, firmware, or hardware of the electronic appliance.

Although the present invention has been described in terms of a particular embodiment, it is not intended that the invention be limited to this embodiment. For example, the power-consumption-decreasing methods and techniques of various embodiments of the present invention may be undertaken by any of many different software, firmware, or hardware components, alone or in combination, within an electronic appliance. The strategies may be user-defined, user-modifiable, or entirely manufacturer-designed and manufacturer-implemented. Although configuring display modes that decrease the portion of the display device used for displaying information and that increase the average portion of the display component that does not emit light are two basic principles of many of the different power-consumption-decreasing strategies that represent embodiments of the present invention, other techniques for decreasing the time-averaged portion of the display device emitting light can be employed as alternative embodiments of the present invention. For example, a selected fraction of pixels can be disabled over the entire screen to provide lower power-consuming, lower resolution displays. Similarly, blank, blackened screen display may be interleaved with information-containing display to effectively decrease the refresh rate of the screen. Additional keyboard features, keys, and other components can be moved into the main display component to simplify the hardware and firmware design of an electronic appliance, relying on the fact that only light-emitting regions of the display screen consume power. The energy-conserving techniques that represent embodiments of the present invention can be used, as one example, for low power video playback. Full screen, low power-consuming video display can be possible using lower scan rates, restricted color display, decreasing display intensity, and other energy-conserving techniques. Decreasing the portion of the screen used for video display can significantly increase energy conservation in the device. Although particularly useful in portable devices, the low power-consumption display modes may be usefully employed in other computing systems using DLEMB display components to prevent wasteful energy expenditure, to lower display component costs, and to increase display component lifetimes.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for displaying information in an electronic, computing-and-information-displaying appliance, the appliance having a display component that uses a direct-light-emitting display medium, the display component having display regions, the method comprising:
setting a power-consumption-decreasing configuration of the electronic, computing-and-information-displaying appliance that decreases power consumption by the display component during display of information; and
operating the electronic, computing-and-information-displaying appliance according to the power-consumption-decreasing configuration.

2. The method of claim 1, wherein the power-consumption-decreasing configuration specifies a display mode of the electronic, computing-and-information-displaying appliance that reduces a percentage of time of information display during which the display regions emit light.

3. The method of claim 2, wherein the power-consumption-decreasing configuration of the electronic, computing-and-information-displaying appliance further specifies a display mode in which display regions emit no light and dark colors in preference to emitting white light and bright colors.

4. The method of claim 2, wherein the power-consumption-decreasing configuration of the electronic, computing-and-information-displaying appliance further specifies a display mode that preferentially displays dark and black display backgrounds.

5. The method of claim 2, wherein the power-consumption-decreasing configuration of the electronic, computing-and-information-displaying appliance further specifies a display mode that provides at least one reduced-content display configuration in which selected display features are not displayed.

6. The method of claim 2, wherein the power-consumption-decreasing configuration of the electronic, computing-and-information-displaying appliance further specifies a display mode for the configuration that displays no color or primary colors in preference to non-primary colors and white.

7. The method of claim 2, wherein the power-consumption-decreasing configuration of the electronic, computing-and-information-displaying appliance further specifies a display mode that decreases the size of displayed information.

8. The method of claim 2, wherein the power-consumption-decreasing configuration of the electronic, computing-and-information-displaying appliance further specifies a display mode that displays text in colors visually differentiable from a dark background on dark or colorless backgrounds.

9. The method of claim 2, wherein the power-consumption-decreasing configuration of the electronic, computing-and-information-displaying appliance further specifies a display mode that preferentially displays text and features in gray portions of a grayscale between white and black on a dark background.

10. The method of claim 1, wherein setting the power-consumption-decreasing configuration of the electronic, computing-and-information-displaying appliance decreases an average intensity at which regions of the display component emit light during display of information.

11. The method of claim 1, wherein setting the power-consumption-decreasing configuration of the electronic, computing-and-information-displaying appliance that decreases power consumption is provided by a user interface that enables a user to set the configuration.

12. The method of claim 1 wherein operating the electronic, computing-and-information-displaying appliance according to the power-consumption-decreasing configuration further comprises invoking power-consumption-decreasing logic dynamically.

13. The method of claim 12 wherein the power-consumption-decreasing logic is invoked according to discretely specified remaining-stored-energy levels.

14. The method of claim 12 wherein the power-consumption-decreasing logic is invoked according to at least one parameterized, quasi-continuous function of remaining-stored-energy level.

15. The method of claim 12 wherein the power-consumption-decreasing logic is invoked according to discretely specified time points.

16. The method of claim 12 wherein the power-consumption-decreasing logic is invoked according to at least one parameterized, quasi-continuous function of time.

17. A computer readable medium having computer-executable instructions for performing a method comprising:
accessing a power-consumption-decreasing configuration that decreases power consumption by a display component during display of information; and
operating an electronic, computing-and-information displaying appliance according to the accessed power-consumption-decreasing configuration.

18. A processing system comprising:
an electronic, computing-and-information displaying appliance, the computing-and-information displaying appliance having a display component including a direct-light-emitting display medium; and
a computer readable medium coupled to the electronic, computing-and-information displaying appliance, the computer readable medium containing a power-consumption-decreasing configuration for the electronic, computing-and-information displaying appliance.

19. An electronic, computing-and-information displaying appliance comprising:
a display component that uses a direct-light-emitting display medium; and
a power-consumption-decreasing configuration that decreases power consumption by the display component during display of information.

20. A computer-readable data-storage medium in a computing-and-information-displaying appliance, the appliance including a display component having display regions, the computer-readable data-storage medium containing a display-component-power-consumption-decreasing configuration specifying a display mode that directs the electronic, computing-and-information-displaying appliance to reduce a percentage of the time of information display during which regions of the display component emit light.

21. The computer-readable data-storage medium of claim 20 further containing a configuration specifying a display mode that directs the electronic, computing-and-information-displaying appliance to reduce an average intensity at which regions of the display component emit light during display of information.

22. A computer-readable data-storage medium in a computing-and-information-displaying appliance, the appliance including a display component having display regions, the computer-readable data-storage medium containing a display-component-power-consumption-decreasing configuration specifying a display mode that directs the electronic, computing-and-information-displaying appliance to reduce an average intensity at which regions of the display component emit light during display of information.

23. The computer-readable data-storage medium of claim 22 further containing a configuration specifying a display mode that directs the electronic, computing-and-information-displaying appliance to reduce a percentage of the time of information display during which regions of the display component emit light.

24. Power-management logic for controlling power consumption by a display component of an electronic, computing-and-information-displaying appliance, the power-management logic comprising:
logic that determines when to invoke each of a number of power-management methods that decrease display-component power consumption during information display by the display component; and
logic that executes the number of power-management methods that decrease display-component power consumption during information display by the display component.

25. The power-management logic of claim 24 wherein the power management logic is implemented as logic circuits within the electronic, computing-and-information-displaying appliance.

26. The power-management logic of claim 24 wherein the power management logic is implemented as firmware within the electronic, computing-and-information-displaying appliance.

27. The power-management logic of claim 24 wherein the power management logic is implemented as at least one software routines stored within the electronic, computing-and-information-displaying appliance.

28. The power-management logic of claim 24 wherein the power management logic is implemented as a combination of a plurality of:
software routines stored within the electronic, computing-and-information-displaying appliance;
firmware within the electronic, computing-and-information-displaying appliance; and
logic circuits within the electronic, computing-and-information-displaying appliance.

29. The power-management logic of claim 24 wherein the number of power-management methods include power-management methods that configure the electronic, computing-and-information-displaying appliance to decrease a percentage of the time of information display during which regions of the display component emit light.

30. The power-management logic of claim 29 wherein the power-management methods that configure the electronic, computing-and-information-displaying appliance to decrease a percentage of the time of information display during which regions of the display component emit light include a power-management method that configures display schemes in which dark regions are displayed in preference to colored and white regions.

31. The power-management logic of claim 29 wherein the power-management methods that configure the electronic, computing-and-information-displaying appliance to decrease a percentage of the time of information display during which regions of the display component emit light include a power-management method that configures dark or black display backgrounds.

32. The power-management logic of claim 29 wherein the power-management methods that configure the electronic, computing-and-information-displaying appliance to decrease a percentage of the time of information display during which regions of the display component emit light include a power-management method that configures reduced-content display schemes in which selected display features are not displayed.

33. The power-management logic of claim 29 wherein the power-management methods that configure the electronic, computing-and-information-displaying appliance to decrease a percentage of the time of information display during which regions of the display component emit light include a power-management method that configures a preference for display of primary colors.

34. The power-management logic of claim 29 wherein the power-management methods that configure the electronic, computing-and-information-displaying appliance to decrease a percentage of the time of information display during which regions of the display component emit light include a power-management method that configures a decrease in the size of displayed information.

35. The power-management logic of claim 29 wherein the power-management methods that configure the electronic, computing-and-information-displaying appliance to decrease a percentage of the time of information display during which regions of the display component emit light include a power-management method that configures display of text in relatively light colors on a dark background.

36. The power-management logic of claim 29 wherein the power-management methods that configure the electronic, computing-and-information-displaying appliance to decrease a percentage of the time of information display during which regions of the display component emit light include a power-management method that configures display of information at low resolution on a dark or black background.

37. The power-management logic of claim 24 wherein the number of power-management methods include power-management methods that configure the electronic, computing-and-information-displaying appliance to decrease an average intensity at which regions of the display component emit light during display of information.

38. The power-management logic of claim 24 further including:
signal-adjusting logic that adjusts a signal applied to regions of the display component to compensate for deterioration of a direct light-emitting medium within the display component.

39. An electronic, computing-and-information displaying appliance comprising:
a display component; and
power-management logic that determines when to invoke each of a number of power-management methods that decrease power consumption by the display component during information display by the display component, and that executes the number of power-management methods that decrease display-component power consumption during information display by the display component.

40. A method for displaying information in an electronic, computing-and-information-displaying appliance that includes a display component that uses a direct-light-emitting display medium, the method comprising:
detecting degradation in the intensity of at least one portion of the spectrum of visible light emitted by the display component in response to a light-emission-stimulating signal applied to the display component; and
increasing the signal applied to the display component to direct emission of light in the degraded portion of the spectrum.

41. A method for displaying information in an electronic, computing-and-information-displaying appliance that includes a display component that uses a direct-light-emitting display medium, the method comprising:
monitoring the amount of time and intensity of display for various regions of the display component; and
altering a display-component-related configuration of the electronic, computing-and information-display appliance to distribute time and intensity of light emission evenly over the various regions of the display component.
